(19) United States
(12) Patent Application Publication
(10) Pub. No.: US 2018/0345314 A1
(43) Pub. Date: Dec. 6, 2018

(54) Ejaculate Dispensing Device and Method of Making the Same

(71) Applicant: Marcus Burke, Orlando, FL (US)

(72) Inventor: Marcus Burke, Orlando, FL (US)

(21) Appl. No.: 15/609,063

(22) Filed: May 31, 2017

(51) Int. Cl. B05C 17/005

(52) U.S. Cl. CPC B05C 17/00569

(57) ABSTRACT

An ejaculate dispensing device includes: a pump head including a pump trigger hingedly associated with the pump head, the pump head comprising a threaded lower end and an outlet end; a dip tube located on the lower end of the pump head, the dip tube terminating at a distal end extending from the lower end of the pump head; an adapter coupled to the outlet end of the pump head, the adapter reducing a diameter of the outlet end to an adapter outlet end; an elongate section of flexible tubing coupled to the adapter outlet end, the elongate section of flexible tubing comprising a first end proximate to the adapter outlet end and a second end distal from the first end; and a nozzle inserted into the second end of the elongate section of flexible tubing.

### FIELD

This disclosure relates to the field of sexual devices. More particularly, this disclosure relates to an ejaculate dispensing device that simulates ejaculation.

### BACKGROUND

Various sexual devices exist that provide sexual stimulation and may replicate the act of male ejaculation. For example, U.S. Pat. No. 6,350,230 describes a sexual aid device that includes elements to dispense a fluid and thereby simulate ejaculation. Similarly, U.S. Pat. No. 7,163,508 describes a lubricating sexual aid that also emits a fluid from the device to simulate ejaculate.

While these and other devices provide an artificial means of ejaculation, often the simulated act is unrealistic and creates an unrealistic appearance of the act of ejaculating. Further, these devices are unrealistic in appearance and may not be suitable for use in the production of adult entertainment.

What is needed, therefore, is an ejaculate dispensing device that creates a realistic simulation of the act of ejaculating.

### SUMMARY

The above and other needs are met by an ejaculate dispensing device. In a first aspect, an ejaculate dispensing device includes: a pump head including a pump trigger hingedly associated with the pump head, the pump head comprising a threaded lower end and an outlet end; a dip tube located on the lower end of the pump head, the dip tube terminating at a distal end extending from the lower end of the pump head; an adapter coupled to the outlet end of the pump head, the adapter reducing a diameter of the outlet end to an adapter outlet end; an elongate section of flexible tubing coupled to the adapter outlet end, the elongate section of flexible tubing comprising a first end proximate to the adapter outlet end and a second end distal from the first end; and a nozzle inserted into the second end of the elongate section of flexible tubing.

In one embodiment, the ejaculate dispensing device further includes a reservoir bottle having a threadable upper end shaped to engage the threaded lower end of the pump head. In another embodiment, the reservoir bottle has a volume of less than six ounces.

In yet another embodiment, the elongate section of flexible tubing is translucent. In one embodiment, the adapter is shaped to fit over the outlet end of the pump head.

In another embodiment, the adapter further comprising an adapter outlet shaped to have a press fit engagement with the elongate section of flexible tubing.

In a second aspect, a method of making an ejaculate dispensing device includes: providing a pump head having a threaded lower end, a pump handle hingedly associated with the pump head, an elongate dip tube extending from the pump head, and sprayer nozzle located on an outlet end of the pump head; trimming the elongate dip tube to a length such that the elongate dip tube terminates adjacent a bottom end of the pump head; coupling an adapter to the end of the sprayer nozzle, the adapter reducing a diameter of the end of the sprayer nozzle to an outlet end sized to receive a piece of elongate flexible tubing; coupling a section of elongate flexible tubing to the outlet end of the adapter, the elongate flexible tubing extending from a proximate end adjacent the adapter to a distal end; coupling a nozzle to the distal end of the elongate flexible tubing; and providing a reservoir bottle including a threaded upper end shaped to engage the threaded lower end of the pump head, the reservoir bottle having a volume of less than six ounces.

### BRIEF DESCRIPTION OF THE DRAWINGS

Further features, aspects, and advantages of the present disclosure will become better understood by reference to the following detailed description, appended claims, and accompanying figures, wherein elements are not to scale so as to more clearly show the details, wherein like reference numbers indicate like elements throughout the several views, and wherein:

FIG. 1 shows an ejaculate dispensing device according to one embodiment of the present disclosure;

FIG. 2 shows a pump head and adapter of an ejaculate dispensing device according to one embodiment of the present disclosure;

FIG. 3 shows a pump head and elongate tubing of an ejaculate dispensing device according to one embodiment of the present disclosure;

FIG. 4 shows a close up view of an adaptor according to one embodiment of the present disclosure; and

FIG. 5 shows a close up view of a flexible tubing nozzle according to one embodiment of the present disclosure.

### DETAILED DESCRIPTION

Various terms used herein are intended to have particular meanings. Some of these terms are defined below for the purpose of clarity. The definitions given below are meant to cover all forms of the words being defined (e.g., singular, plural, present tense, past tense). If the definition of any term below diverges from the commonly understood and/or dictionary definition of such term, the definitions below control.

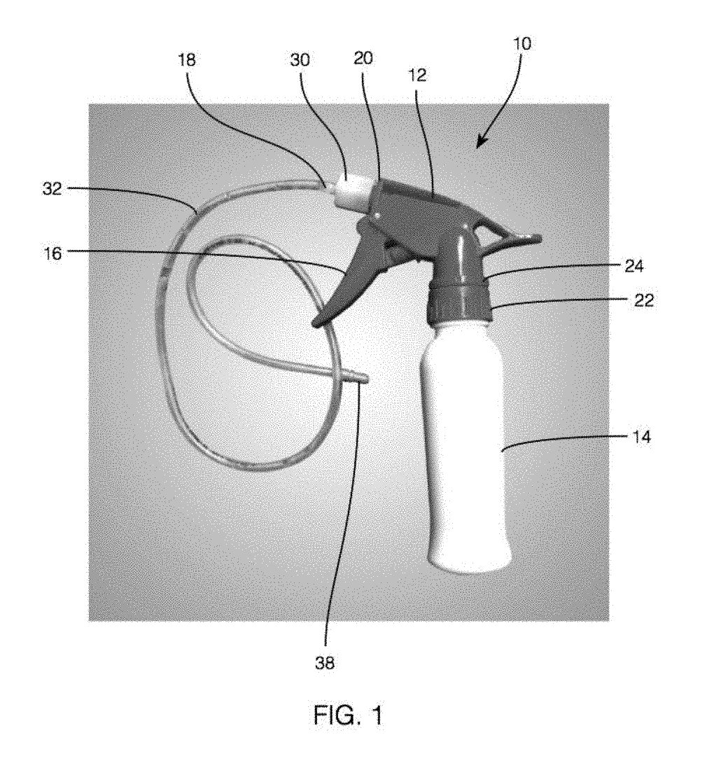

FIG. 1 shows a basic embodiment of an ejaculate dispensing device 10 for realistically dispensing an ejaculate fluid from the ejaculate dispensing device 10. The ejaculate dispensing device 10 advantageously dispenses an ejaculate material from the dispensing device 10 with sufficient velocity such that operation of the ejaculate dispensing device 10 creates a realistic appearance of an act of ejaculating.

As referred to herein, a suitable ejaculate material is preferably an artificial substance having a viscosity and consistency similar to that of natural ejaculate. Various known artificial ejaculate materials may be suitable for use with the ejaculate dispensing device 10.

With further reference to FIG. 1, the ejaculate dispensing device 10 includes a pump head 12 and an ejaculate reservoir 14 removably attached to the pump head 12. The pump head 12 includes a pump trigger 16 hingedly attached to the pump head 12. The pump trigger 16 is mechanically coupled with the pump head 12 such that operation of the pump trigger 16 operates pumping of the pump head 12. Internal components of the pump head 12 may be formed according to known pumping devices, such as a piston and spring configuration wherein the piston is mechanically associated with the pump trigger 16. The pump head 12 includes an outlet end 18 located at a front 20 of the pump head 12. The pump head 12 further includes a threaded lower end 22 located on a bottom 24 of the pump head.

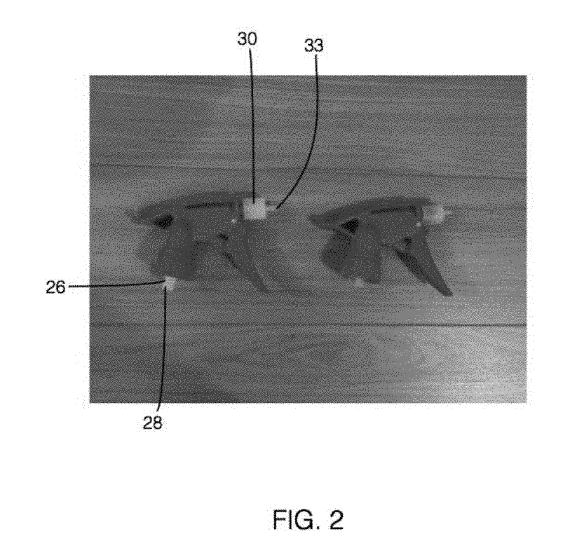

Referring to FIG. 2, a dip tube 26 is coupled to the pump head 12 and in fluid communication with the outlet end 18 through the pump head 12. The dip tube 26 extends from a proximal end adjacent the threaded lower end 22 of the pump head to a distal end 28 that extends into the ejaculate reservoir 14. The dip tube 26 preferably has a length such that the distal end 28 of the dip tube 26 terminates adjacent at a point that is proximal to the bottom 24 of the pump head 12 such that the dip tube 26 does not extend towards a bottom of the ejaculate reservoir. The dip tube 26 is preferably formed of a resiliently flexible tubing such that the dip tube 26 maintains a shape of the dip tube 26 when the dip tube is located within the ejaculate reservoir 14 and a ejaculate material is also in the ejaculate reservoir 14.

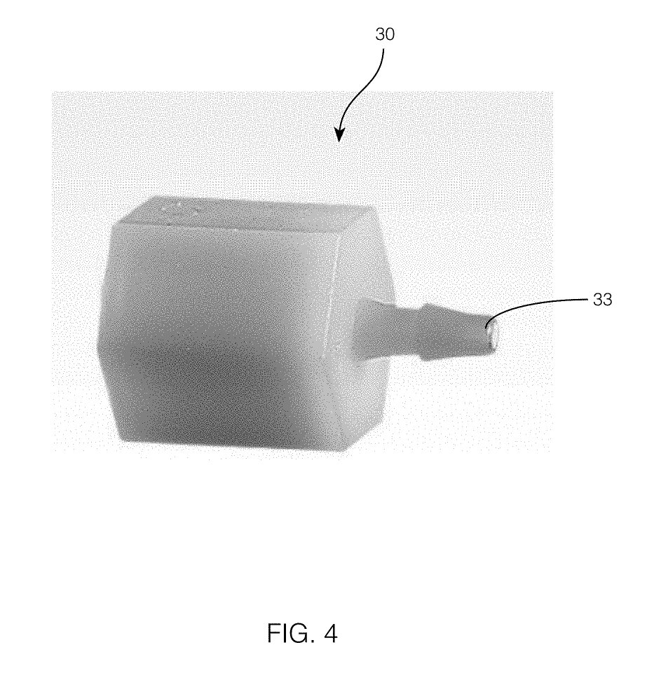

An adapter 30 (FIG. 4) is attached to the outlet end 18 of the pump head 12. The adapter 30 preferably reduces a diameter of the outlet end 18 of the pump head 12 such that an elongate section of tubing 32 may be coupled with the pump head 12 through the adapter 30. The adapter 30 preferably fits over the outlet end 18 of the pump head 12, and is preferably held in place such as with an adhesive or by threaded engagement of the adapter 30 to the pump head 12. The adapter 30 includes an adapter outlet 33 formed on a distal end of the adapter, the adapter outlet 32 having a diameter such that the elongate section of tubing 32 may be press fit over the adapter outlet 32. The adapter outlet 33 is preferably barbed or similarly shaped to retain the elongate section of tubing 32 on the adapter outlet 33.

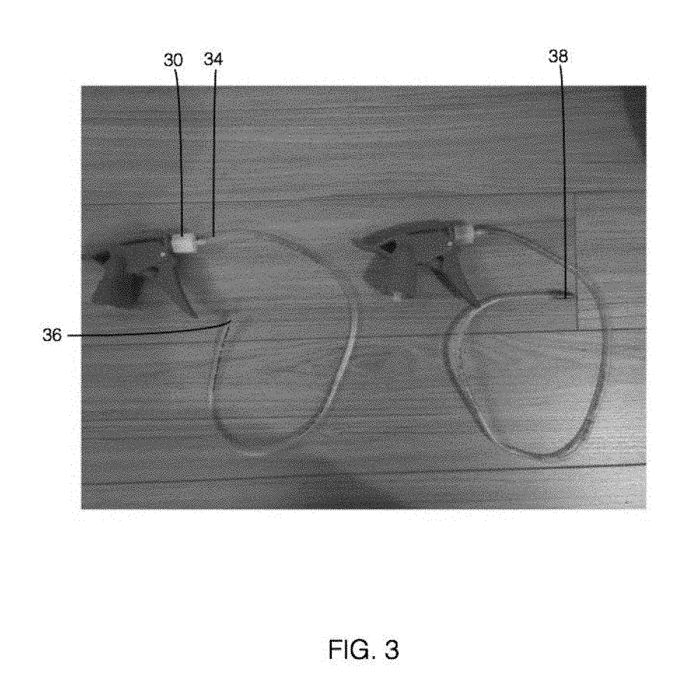

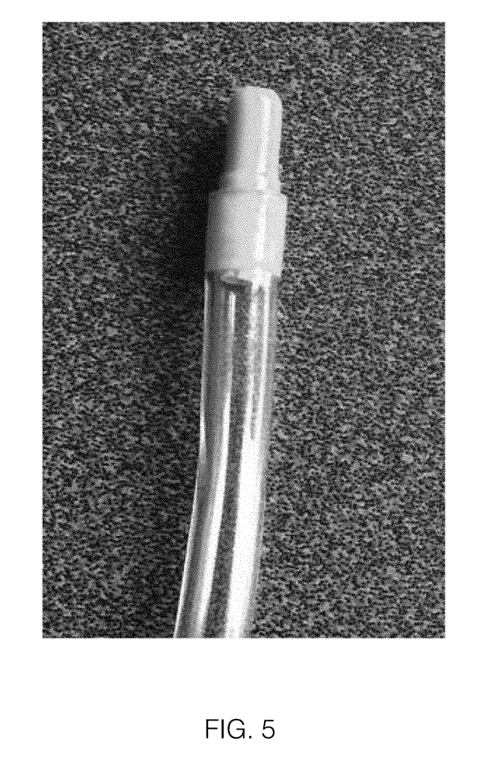

Referring to FIG. 3, the elongate section of tubing 32 is preferably formed of a flexible material, and is preferably formed of medical tubing or other like materials. Suitable materials include hypoallergenic tubing that does not kink when manipulated or to adhere to bare skin. The elongate section of tubing 32 extends from a first end 34 adjacent to the outlet end 18 of the pump head 12 to a distal end 36 that is distal from the pump head 12. The elongate section of tubing 32 is preferably elongate in length, and preferably has a length greater than approximately three inches. A flexible tubing nozzle 38 (FIG. 5) is located at the distal end 36 of the elongate section of tubing 32, and includes an outlet having a reduced size relative to the elongate section of tubing 32. The flexible tubing nozzle 38 is preferably a highly visible color, such as a bright green, such that the flexible tubing nozzle 38 is visible if it appears within a camera shot of a production.

Referring again to FIG. 1, the ejaculate reservoir 14 is preferably shaped to threadably engage with the lower end 22 of the pump head 12. The ejaculate reservoir 14 is preferably undersized relative to a size of the pump head 12, and preferably has a volume of six ounces or less. The ejaculate reservoir 14 is preferably formed of a polymer and may include transparent walls such that contents of the ejaculate reservoir 14 are viewable.

In operation, an ejaculate material is placed within the ejaculate reservoir 14. To operate the ejaculate dispensing device 10, a user inverts the ejaculate dispensing device 10 such that the ejaculate material flows into the dip tube 26. The user manipulates the pump trigger 16 to initially draw ejaculate material into the dip tube 26, into the pump head 12, and through the elongate section of flexible tubing 32. When the ejaculate material is initially primed into the pump head 12 and elongate section of flexible tubing 32, the user may subsequently manipulate the pump trigger 16 to eject ejaculate material from the flexible tubing nozzle 38.

A user may hold the dispensing device 10 in one of the user's hand and conceal the device behind the user. The elongate flexible tubing 32 allows the flexible tubing nozzle 38 to be located distally from the pump head 12, and the flexible tubing 32 may be routed along a user's body to a desired location while remaining out of a line of sight of a camera used in a production.

It has been found that the unique combination of elements in the ejaculate dispensing device 10 creates dispenses the ejaculate material in a realistic manner and allows the pump head 12 to pump and dispense the relatively viscous ejaculate material. Further, providing a reservoir chamber having a relatively small size, such as a preferable size of 8 ounces or less, has been found to enhance operation of the device 10. The ejaculate dispensing device 10 of the present disclosure advantageously allows a user to dispense an ejaculate material with a velocity sufficient to create the appearance of natural act of ejaculating. The ejaculate dispensing device 10 is readily refillable and easily cleaned. The ejaculate dispensing device 10 is particularly well suited for adult film production sets, where the ejaculate dispensing device 10 may recreate a natural appearing act of ejaculation without requiring a performer to perform the act.

The foregoing description of preferred embodiments of the present disclosure has been presented for purposes of illustration and description. The described preferred embodiments are not intended to be exhaustive or to limit the scope of the disclosure to the precise form(s) disclosed. Obvious modifications or variations are possible in light of the above teachings. The embodiments are chosen and described in an effort to provide the best illustrations of the principles of the disclosure and its practical application, and to thereby enable one of ordinary skill in the art to utilize the concepts revealed in the disclosure in various embodiments and with various modifications as are suited to the particular use contemplated. All such modifications and variations are within the scope of the disclosure as determined by the appended claims when interpreted in accordance with the breadth to which they are fairly, legally, and equitably entitled.

1. An ejaculate dispensing device for creating an appearance of realistic ejaculating, the ejaculate dispensing device comprising:
a pump head including a pump trigger hingedly associated with the pump head, the pump head comprising a threaded lower end and an outlet end;
a dip tube located on the lower end of the pump head, the dip tube terminating at a distal end extending from the lower end of the pump head, wherein the distal end of the dip tube is in close proximity to the lower end of the pump head such that a viscous fluid within an attached reservoir flows into the dip tube when the ejaculate dispensing device is inverted;
an adapter coupled to the outlet end of the pump head, the adapter reducing a diameter of the outlet end to an adapter outlet end; the adapter further comprising a barbed adapter outlet;
an elongate section of translucent flexible tubing coupled to the barbed adapter outlet end, the elongate section of flexible tubing comprising a first end proximate to the adapter outlet end and a second end distal from the first end; and
a brightly colored nozzle inserted into the second end of the elongate section of flexible tubing such that the brightly colored nozzle is visible if not concealed during use.

2. The ejaculate dispensing device of claim 1, further comprising a reservoir bottle having a threadable upper end shaped to engage the threaded lower end of the pump head.

3. The ejaculate dispensing device of claim 2, wherein the reservoir bottle has a volume of less than six ounces.

4. (canceled)

5. The ejaculate dispensing device of claim 1, wherein the adapter is shaped to fit over the outlet end of the pump head.

6. The ejaculate dispensing device of claim 5, the adapter outlet shaped to have a press fit engagement with the elongate section of flexible tubing.

7. A method of making an ejaculate dispensing device, the method comprising:
providing a pump head having a threaded lower end, a pump handle hingedly associated with the pump head, an elongate dip tube extending from the pump head, and sprayer nozzle located on an outlet end of the pump head, the pump head sized to fit with an original reservoir of the pump head;
trimming the elongate dip tube to a length such that the elongate dip tube terminates adjacent a bottom end of the pump head, wherein a distal end of the dip tube is in close proximity to the bottom end of the pump head such that a viscous fluid within an attached reservoir flows into the dip tube when the ejaculate dispensing device is inverted;
coupling an adapter to the end of the sprayer nozzle, the adapter reducing a diameter of the end of the sprayer nozzle to an outlet end sized to receive a piece of elongate flexible tubing;
coupling the section of elongate flexible tubing to the outlet end of the adapter, the elongate flexible tubing extending from a proximate end adjacent the adapter to a distal end;
coupling a brightly colored nozzle to the distal end of the elongate flexible tubing; and
providing a reservoir bottle including a threaded upper end shaped to engage the threaded lower end of the pump head, the reservoir bottle having a volume of less than six ounces and a volume that is less than a volume of the original reservoir of the pump head.
